(19) United States
(12) Patent Application Publication
(10) Pub. No.: US 2006/0109248 A1
(43) Pub. Date: May 25, 2006

(54) Pseudo trackball optical pointing apparatus

(75) Inventor: Chih Wen Su, Taipei (TW)

Correspondence Address: G. LINK CO., LTD;Suite 137, PMB 174, 931 West, 75th Street, Naperville, IL, 60565, US

(73) Assignee: BEHAVIOR COMPUTER TECH CORP.

(21) Appl. No.: 10/993,844

(22) Filed: Nov. 22, 2004

(51) Int. Cl. G09G 5/08

(52) U.S. Cl. 345/167

(57) ABSTRACT

The present invention is related to a pseudo trackball optical pointing apparatus comprising of a palm-manipulated part of which includes at least a rotating ball by finger's manipulation and the ball is used to reflects the incident light, and an optical module of which produces a correspondingly indicative signal due to the incident light and the optical module at least includes an optical apparatus to produce the incident light and an optical sensor to receive the reflective light and also the lens to guide the incident light upon the ball and further to focus the reflective light to the optical sensor, the palm-manipulated part is placed at a preset angle to the optical module.

### FIELD OF THE INVENTION

The present invention is related to an optical pointing apparatus, especially to a pseudo trackball optical pointing apparatus by using the same manipulation of trackball pointing apparatus and the optical module to produce pointing signals placed on the palm-manipulated part of the pseudo trackball optical pointing apparatus at a preset angle.

### BACKGROUND OF THE INVENTION

The manipulation of the used optical mouse is to move on a surface to produce a correspondingly indicative signal, accordingly, the used optical mouse works under a condition of touchable moving surface and a touch in parallel. In case of a tilt from the surface by part of the used optical mouse, that is, to keep a tilt angle between the used optical mouse and the surface for use that makes the optical mouse fail to produce an indicative signal. Also, the above stated surface is not a transparent surface, such as glass. So these many limitations are the drawbacks of the used optical mouse.

Another used trackball pointing device is not constrained by a movable surface, however, the coding means of the used trackball pointing device uses the trackball to drive X-axis coding wheel and Y-axis coding wheel in order to produce the indicative signal. Since using the used trackball pointing device with X-axis coding wheel and Y-axis coding wheel is limited by the coding wheel and fails to increase the resolution of indicative signals, the resolution of the used optical mouse is better than the used trackball pointing device.

The inventor of the present invention investigates the drawbacks of the used optical mouse and the used trackball pointing device to combine the merits of the used mouse and the used trackball pointing device and further invents a pseudo trackball optical pointing apparatus with any preset manipulated angles.

### SUMMARY OF THE INVENTION

The object of the present invention is to provide a pseudo trackball optical pointing apparatus by using the same manipulation of trackball pointing device and the optical module to produce pointing signals.

Another object of the present invention is to provide a pseudo trackball optical pointing apparatus with a palm-manipulated part which includes a ball at a preset angle.

To achieve the above purpose, the present invention provides a pseudo trackball optical pointing apparatus comprising of a palm-manipulated part which includes at least a rotating ball by finger's manipulation and the ball is used to reflect the incident light, and an optical module which produces a correspondingly indicative signal due to the incident light and the optical module which at least includes an optical apparatus to produce the incident light and an optical sensor to receive the reflective light and also the lens to guide the incident light upon the ball and further to focus the reflective light to the optical sensor, the palm-manipulated part is placed at a preset angle to the optical module.

### BRIEF DESCRIPTION OF THE DRAWINGS

The above objects and advantages of the present invention will become more apparent with reference to the appended drawings wherein:

FIG. 1 shows the first embodiment of the present invention of the pseudo trackball optical pointing apparatus;

FIG. 2 is a decomposed structural drawing of the present invention of the pseudo trackball optical pointing apparatus;

FIG. 3 shows the sectional drawing of the first embodiment of the present invention;

FIG. 4 shows the second embodiment of the present invention of the pseudo trackball optical pointing apparatus;

FIG. 5 shows the sectional drawing of the second embodiment of the present invention;

FIG. 6A to 6C shows the third embodiment of the present invention of the pseudo trackball optical pointing apparatus at any viewing angle; and

FIG. 7 shows the sectional drawing of the third embodiment of the present invention.

### DETAILED DESCRIPTION OF THE INVENTION

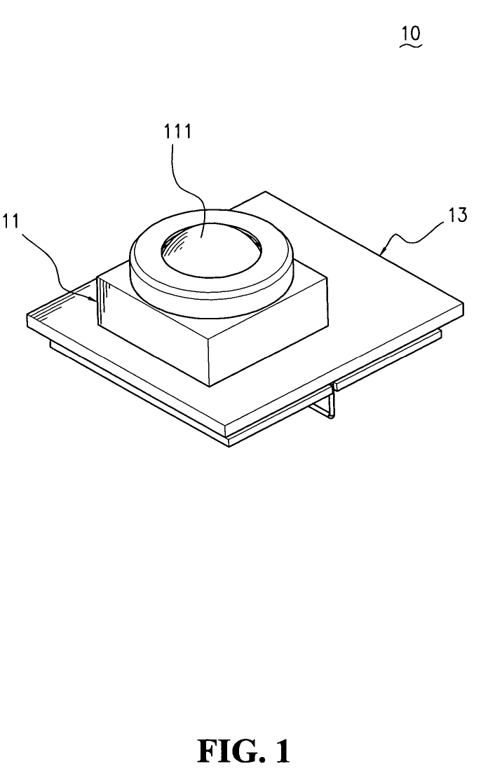

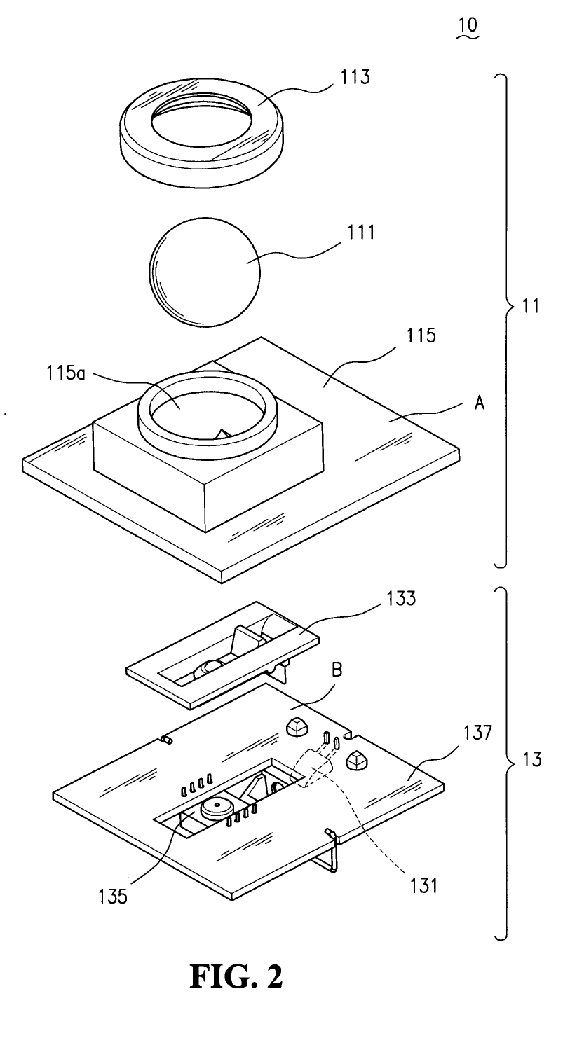

Referring to FIG. 1 and FIG. 2, the present invention is a pseudo trackball optical pointing apparatus 10 comprising of a palm-manipulated part 11 and an optical module 13. The palm-manipulated part 11 is used for the user to manipulate pointing apparatus 10 to move the ball 111 by the finger and make the ball 111 rotate as the manipulation of the used trackball pointing apparatus. The present invention of optical module 13 is capable of using the optical module of the used optical mouse, the optical module 13 produces an incident light 131a upon the ball 111 and reflects a reflective light 131b to be received by optical module 13 and then produces a corresponding pointing signal. The placement of palm-manipulated part 11 and optical module 13 of the present invention is capable of being placed at a preset angle, that is, the side A of palm-manipulated part 11 and the side B of optical module 13 form an angle which is placed at a preset angle.

FIG. 1 shows the first embodiment of the present invention of the pseudo trackball optical pointing apparatus. In FIG. 1, the side A and the side B of pointing apparatus 10 is in parallel, that is, the angle between the side A of palm-manipulated part 11 and the side B of optical module 13 is zero degree, palm-manipulated part 11 is placed on optical module 13. Referring to FIG. 2 of the decomposed structural drawing of the present invention of the pseudo trackball optical pointing apparatus, palm-manipulated part 11, except with the ball 111, also includes a lid 113 and a stand 115 to hold the ball 111. In the procedure of assembling palm-manipulated part 11, it first places the ball 111 on the recess 115a of the stand 115 and then fixes with the lid 113 by, for instance, the screw. Optical module 13 mainly includes light source apparatus 131, lens 133 and light sensor 135. The light source apparatus 131, for instance to use the light emission diode (LED), is used to produce incident light 131a. The lens 133 is mainly used to guide incident light 131a to the ball 111 and focus the reflective light 131b to the light sensor 135 with an efficiently receiving effect. The light sensor 135 is used to receive the focused reflective light 131b and produces an indicative signal corresponding to reflective light 131b. The above light source apparatus 131, lens 133 and light sensor 135 are capable of using the substrate 137 of the print circuit board for assembly.

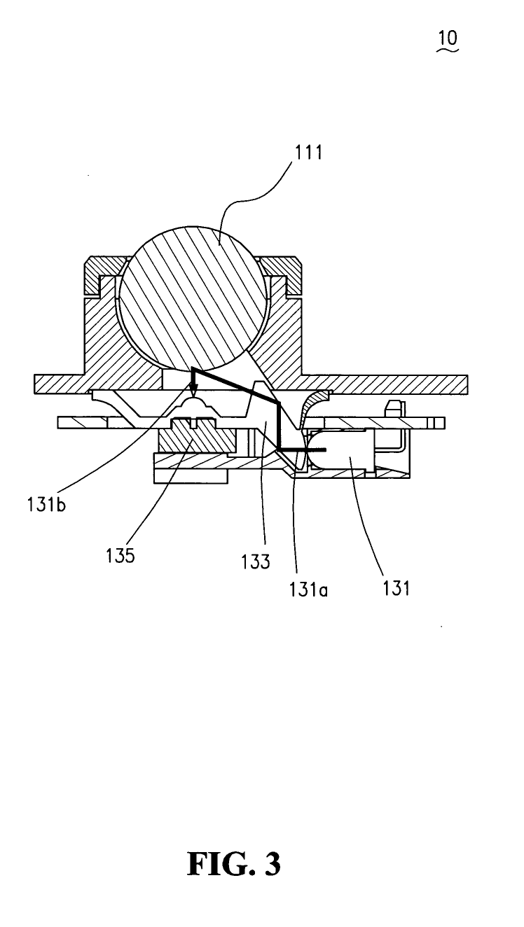

FIG. 3 shows the sectional drawing of the first embodiment of the present invention. In FIG. 3, palm-manipulated part 11 and optical module 13 is placed at zero angle, the light path of incident light 131a and reflective light 131b is practically accomplished. Accordingly, light module 13 can produce a corresponding pointing signal due to the reflective light 131b from the ball 111.

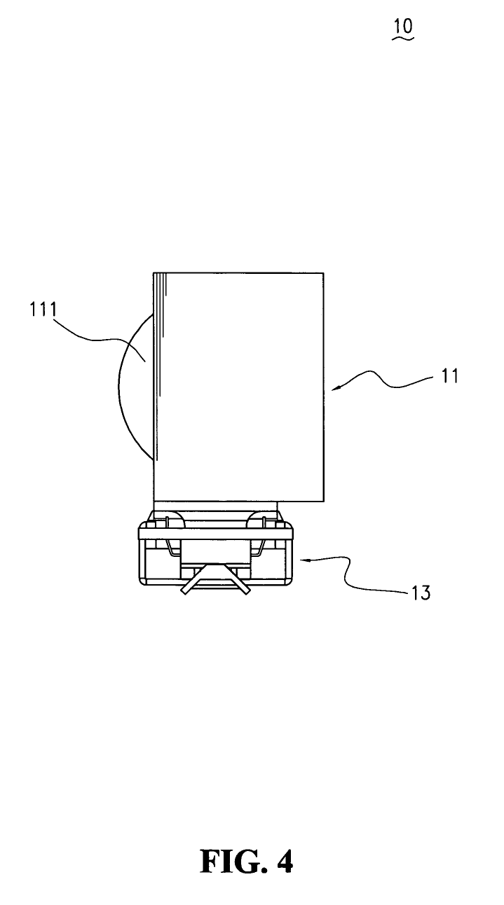

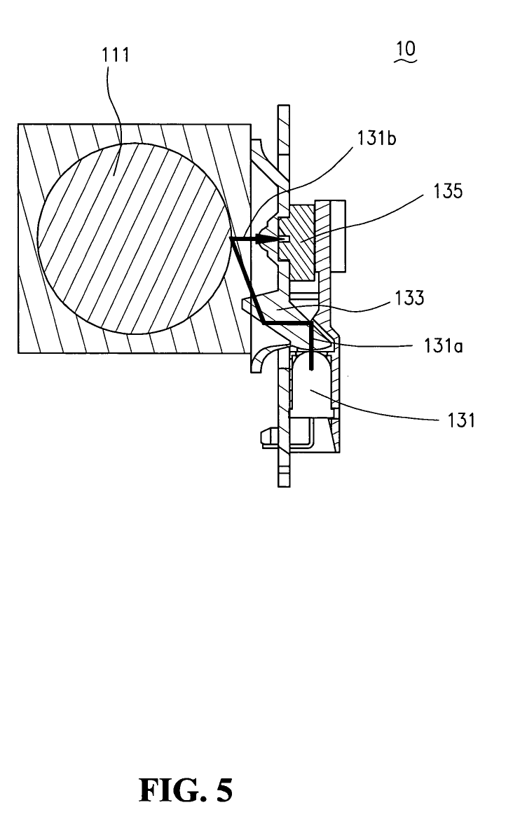

FIG. 4 shows the second embodiment of the present invention of the pseudo trackball optical pointing apparatus. In FIG. 4, the side A and the side B of indicative apparatus 10 is vertical to each other, the angle between the side A of palm-manipulated part 11 and the side B of optical module 13 is preset as 90 degrees, that is, palm-manipulated part 11 is vertically placed on optical module 13. FIG. 5 shows the sectional drawing of the second embodiment of the present invention. In FIG. 5, palm-manipulated part 11 and optical module 13 is placed at 90 degrees, the light path of incident light 131a and reflective light 131b is practically accomplished. Accordingly, light module 13 can produce a corresponding pointing signal due to the reflective light 131b from the ball 111.

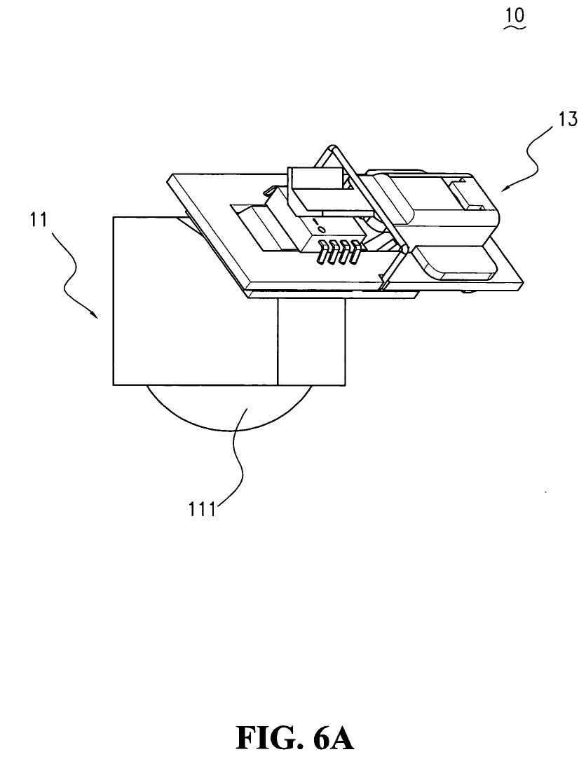

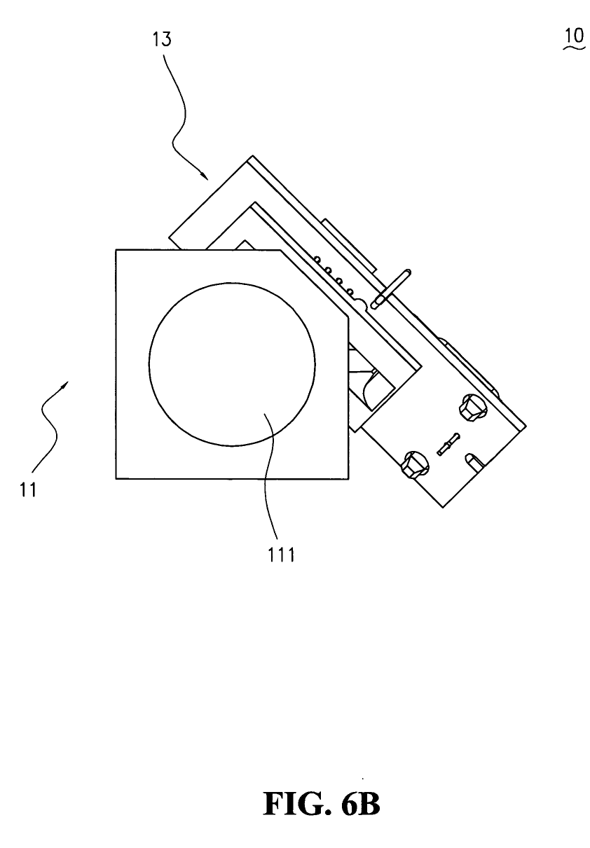

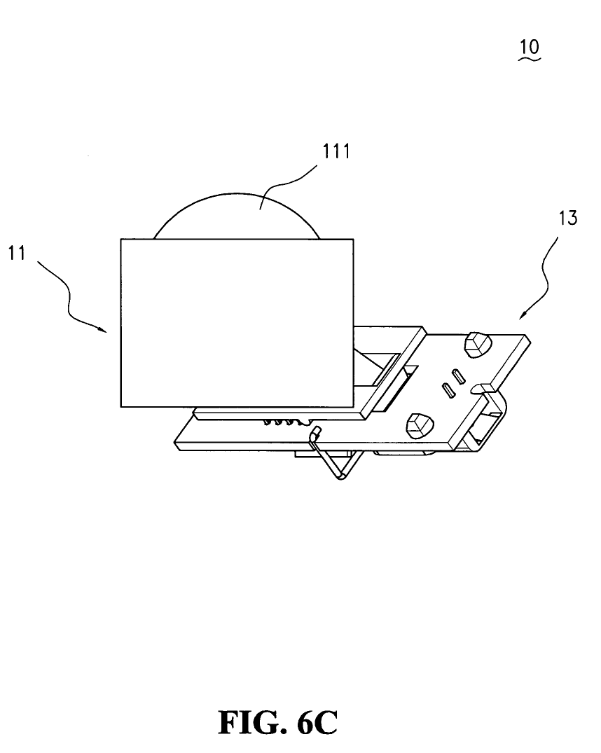

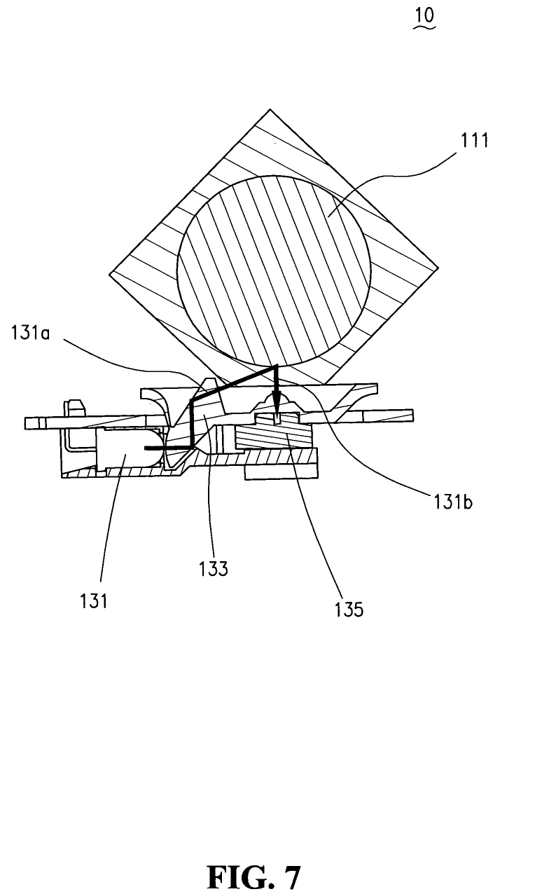

FIG. 6A to 6C shows the third embodiment of the present invention of the pseudo trackball optical pointing apparatus at any viewing angle. In FIG. 6A to FIG. 6C, the side A and the side B of indicative apparatus 10 is 45 degrees to each other, the angle between the side A of palm-manipulated part 11 and the side B of optical module 13 is preset as 45 degrees, that is, palm-manipulated part 11 is slanted upon optical module 13. FIG. 7 shows the sectional drawing of the third embodiment of the present invention. In FIG. 7, palm-manipulated part 11 and optical module 13 is placed at 45 degrees, the light path of incident light 131a and reflective light 131b is practically accomplished. Accordingly, light module 13 can produce a corresponding pointing signal due to the reflective light 131b from the ball 111.

Those familiar with the technology understanding from the reveal of the above three embodiments may place any angle between palm-manipulated part 11 and optical module 13, however, the angle variation is also within the scope of the present invention.

The present invention discloses the pseudo trackball optical pointing apparatus 10, the placing relationship between palm-manipulated part 11 and optical module 13 is not limited at a fixed angle. Consequently, when the pseudo trackball optical pointing apparatus 10 is equipped into the operational panel of the electronic instrument, it can places a proper angle for the pseudo trackball optical pointing apparatus 10 according to practical demands and convenient operations. In the same way, in case of optical module 13 of the above three embodiments of pseudo trackball optical pointing apparatus 10 being closely equipped inside the operational panel and palm-manipulated part 11 being exposed outside the operational panel, palm-manipulated part 11 and the operational panel is on the same horizontal face while referring to the operational panel of the present invention of the first embodiment, and palm-manipulated part 11 and the operational panel is vertical while referring to the operational panel of the present invention of the second embodiment, furthermore, the angle between palm-manipulated part 11 and the operational panel is 45 degrees while referring to the operational panel of the present invention of the third embodiment.

Those who are familiar with the technology should understand that they could do other modifications within the spirit and scope of the present invention. And the coverage of the present invention includes any modification and change within the claims and the corresponding point of view.

What is claim is:

1. A pseudo trackball optical pointing apparatus, comprising:
A palm-manipulated part, which includes at least a rotating ball by finger's movement, wherein the ball is used to reflect a incident light and produce a reflective light;
An optical module, which is used to produce a corresponding pointing signal due to the incident light, wherein the optical module at least includes a light source apparatus to produce the incident light, a light sensor to receive the reflective light, and a lens to guide the incident light to the ball and to focus the reflective light to the light sensor, wherein the palm-manipulated part is placed at a preset angle to the optical module.

2. The pseudo trackball optical pointing apparatus as defined in claim 1, wherein the palm-manipulated part further includes a lid and a stand to hold the ball.

3. The pseudo trackball optical pointing apparatus as defined in claim 1, wherein the palm-manipulated part is placed at a slanted angle to the optical module.

4. The pseudo trackball optical pointing apparatus as defined in claim 3, wherein the slanted angle is 45 degrees.

5. The pseudo trackball optical pointing apparatus as defined in claim 1, wherein the palm-manipulated part is placed at 90 degrees to the optical module.

6. The pseudo trackball optical pointing apparatus as defined in claim 1, wherein the palm-manipulated part is placed at zero angle to the optical module, the palm-manipulated part is placed on the optical module.
